(19) United States
(12) Patent Application Publication
(10) Pub. No.: US 2023/0127720 A1
(43) Pub. Date: Apr. 27, 2023

(54) SYSTEM FOR REAL-TIME MONITORING AND CONTROL OF BOT OPERATIONS

(71) Applicant: Avaya Management L.P., Durham, NC (US)

(72) Inventors: John A. Young, Buntingford (GB); Reinhard P. Klemm, Basking Ridge, NJ (US)

(21) Appl. No.: 17/511,081

(22) Filed: Oct. 26, 2021

(51) Int. Cl. G06Q 30/02; G06N 3/08; H04L 12/58

(52) U.S. Cl. CPC G06Q 30/0281; G06N 3/08; H04L 51/02

(57) ABSTRACT

Artificial intelligence (AI) is often utilized for conducting an interaction with a human, such as a customer of a business. While AI agents may successfully interact with a customer to complete a particular task, in some circumstances, an interaction may be beyond the ability of the AI agent. As a result, supervisor may be presented with indicia of an interaction and provide an input, after the input the AI agent may be able to resume the interaction to a successful conclusion. The input may be to modify an AI agent's behavior or provide a particular input as a portion of the interaction with the customer. The AI agent receives or monitors the input and incorporates such inputs into a subsequent training session to alleviate the need for subsequent human involvement if a similar interaction occurs in in the future.

### FIELD OF THE DISCLOSURE

The invention relates generally to systems and methods for training an artificial intelligence and particularly to providing inputs to alter the behavior of a current and subsequent actions of the artificial intelligence.

### BACKGROUND

A variety of programmatic methods are supported by artificial intelligence conversational bots or “chatbot” or more simply, “bots” to create conversational logic flows that define the bot's behavior for the contact center and interactions with customers. Although the associated programmatic interfaces (e.g., Representational State Transfer or RESTful APIs) often provide considerable flexibility and extensibility for bots, current escalation solutions are limited to detection of resolution flows reaching a dead-end or a customer's request for a supervisor or other agent's intervention.

Existing conversational artificial intelligence (AI) platforms are highly flexible and extensible in nature. Programmatic methods and interfaces can be used to create new/different communication channels and to achieve powerful integrations with third-party applications and backend systems. However, a clear demarcation currently exists between the roles of contact center supervisors/agents and bots. That is, an interaction is provided by a human exclusively or a bot exclusively, while engaged with a customer. The human-bot roles may be interspersed with each other, but at any one time, they are discrete.

### SUMMARY

An ability for a contact center supervisor or agent to provide varying degrees and types of inputs to a bot, at different times during active conversations between the bot and a customer, to steer the conversation and override or alter programmed bot behavior and output may result in far better conversation outcomes for both the customer and the business than a sharp distinction between bot-automated conversations and conversations with a human agent.

The ability for a contact center supervisor or agent to provide varying degrees of inputs to a bot while interacting with a customer can result in far better customer satisfaction and improved business outcomes, without transferring the entire communication to a human agent.

An unsupervised bot-only conversation with a customer may be producing unwanted results, such as evidenced by the bot not understanding the customer's input, not having a programmed response or action for the customer's input, the customer becoming frustrated, by a particular task taking longer than expected, or other communication content. Conversation escalation from a bot to a human agent, as is customary in the prior art and may be unavoidable in situations where only a human is able to understand, or as required to effectively, legally, or per business rules and objectives address a situation, negates the benefits of conversation automation via bots and does nothing to address the bot shortcomings in a future reprisal of the same or similar situation. It is possible that a bot is failing to perform an expected action, but would do so if provided with an input, which may be minor or more substantial, from a human. Once the minor input is provided, the bot-customer interaction may progress normally. More involvement from the human may be required in other circumstances. Any involvement by a human, which leads to the successful conclusion of the interaction, may then automatically be processed as a teaching input to the bot. As a benefit, the bot will be able to and trained to handle the same or similar interactions in the future to reach a successful conclusion without any, or at least less, input from a human.

Existing platforms do not include direct support for a human to assume direct real-time control over a bot. As described herein, systems and methods are provided to enable a human to submit “admin” commands to a bot by using a command-line or other interface. As one benefit, interactions may need to “forget” a prior interaction. One example is in the serial performance of customer demos, even though the bot is trained to learn from such prior interactions. As provided herein, an AI may be refreshed, comprising (1) reset a bot by clearing any conversational history/data so that communication, such as a customer demo, can be repeated quickly, from an initialized starting point; (2) reset the current conversation to its beginning; (3) query the status of ongoing and past conversations; and/or (4) query the configuration of the bot.

In one embodiment, a contact center supervisor/agent is provided the ability to assume varying levels of real-time control over a bot operation as it interacts with a customer. As one benefit, an on-going bot-customer interaction may not be going well and may lead to a bad customer experience or undesirable outcome of the interaction for the business. A supervisor/agent may then seamlessly intervene “behind the scenes” to direct the bot and take remedial actions necessary to resume progress in the bot-customer interaction. Additional embodiments are provided a range of bot controls. For example, at the least intrusive level, a supervisor may simply wish to approve a bot's output before it is shared with the customer. At the other extreme, a supervisor may wish to assume direct control over the bot and either direct all of the bot's responses or exclude the bot and conduct all remaining messaging interactions with the customer. The bot may remain an observing-participant of the conversation as a training input to the bot.

In another embodiment, specific metrics and triggers are defined that initiate connection to a communication device in order to receive human input to provide guidance to the bot. The communication device is also provided with a number of control inputs to receive inputs thereon and then alter the bot's operations. Additionally or alternatively, enhancements to the underlying conversational AI platform to support these controls is provided.

In another embodiment, inputs are provided to a range of bot operations. For example, a human agent may “shadow” and/or pre-approve a bot's interactions, adjust the bot's “tone” with a customer, allow the supervisor to send messages to a customer via the bot, or even take direct control of the bot's operation. Optionally, the bot may explicitly request human intervention. The embodiments herein provide an enhanced ability to interrupt the adaptive artificial intelligent (AI) orchestration engine (or, more simply, orchestration engine) to facilitate more extensive control over a bot and/or an adaptive ability to dynamically augment a bot's programmed logic flow based on a different behavior that was enacted by the supervisor while controlling its operation.

In another embodiment, the management of bots is provided utilizing feedback loops. In one example, a bot's operation is altered and an outcome determined therefrom. For example, if a bot-customer interaction is taking longer than expected or stalling (e.g., repeating the same operations, irrelevant topics, etc.) and the bot's operation is altered, as described herein, and the result is positive (e.g., the interaction advances to a next operation, the interaction concludes successfully, the customer's frustration level decreases, etc.), the bot will learn and repeat the behavior in subsequent interactions. Conversely, if the result is negative (e.g., the interaction does not advance to a next operation, the interaction concludes unsuccessfully, the customer's frustration level increases, etc.), the bot will learn and exclude such actions in subsequent interactions.

In another embodiment, an administrative dashboard is provided, such as to highlight ongoing bot-customer interactions that are more likely to escalate. As a result, a human, via a communication device, may connect to the communication session with the bot and provide an input in order to “nudge” the interaction to get it back on track or otherwise avert the need for more extensive human involvement. A dashboard or similar indicia of performance may be provided to the bot itself. For example, a bot that has self-determined that the interaction is going wrong, or is about to go wrong, may initiate a process (on a common processor or by another device(s)) to review similar conversations. By doing so, similar conversations that also have a similar determination of conversations “going wrong” may be identified as well as the actions taken. As a result, an action that had a favorable result may be selected or, at least, an action that had a non-favorable result is eliminated from consideration.

As described herein, the prior art lacks the fundamental ability for humans to directly intervene and provide a guiding input, or even take real-time control over the bot as it interacts with a customer. These and other needs are addressed by the various embodiments and configurations of the present invention. The present invention can provide a number of advantages depending on the particular configuration. These and other advantages will be apparent from the disclosure of the invention(s) contained herein.

Embodiments described herein are generally directed to enabling a bot to receive human input, such as from a contact center supervisor/agent, and thereby provide various levels of real-time control over a bot as it interacts with a customer. Embodiments described herein provide a fluid level of interaction between human and bot while engaged in an interaction with a customer. Although a customer can generally choose to escalate their session to a live chat or voice agent, they can become frustrated by the time this escalation occurs. Embodiments are also provided to enable a contact center supervisor/agent to be notified and/or assume varying levels of control over the bot earlier within the customer interaction, such as before a customer becomes frustrated to the point of abandoning the interaction or calling for a supervisor. Additionally or alternatively, a set of triggers, query capabilities, intervention methods, bot controls and reporting/visualization are provided to notify and receive inputs from a supervisor. Upon deciding to intervene, the supervisor/agent communication device may initially access the bot via a secure bot admin role.

Bot control is variously embodied. Upon undergoing the required authentication and authorization, a supervisor will be granted access to a Bot Operations Dashboard presenting one or more of the following representative bot controls and/or Realtime status embodiments of ongoing conversations between customers and all bots:

1) Supervisor “pinning” of the Conversation: Enable the supervisor to modify the presentation of the Bot Operations Dashboard to manually and/or automatically “pin” a subset of conversations onto a “pre-intervention” panel, and similarly unpin one or more conversations. Pinned conversations may be presented in a panel or with other increased visibility, as compared to conversations that are not pinned, such as to present display conversations that may be in trouble and require close monitoring, but do not yet warrant immediate intervention.

2) Supervisor Bot Shadowing: When a supervisor initiates “bot shadowing”, the bot submits all of its intended output in a designated conversation to the supervisor for approval before sending it to the customer. The supervisor may override the generated output as needed. Later, the supervisor may “unshadow” the conversation.

3) Supervisor Messaging via the Bot: Upon determining that a customer is highly frustrated by his/her interaction with a bot, the supervisor may suspend bot operation and send a message to the customer via the bot that is intended to defuse the situation. Such a message may include more detailed recommendations.

4) Supervisor Assist of Bot Operation: The supervisor can enter specific commands that alter the bot's behavior from its default settings and programmed conversational logic flow. For example, the supervisor might want the bot to become more verbose with its messaging, adopt a more friendly tone, or perhaps suggest an escalation to live chat agent.

5) Supervisor Takes Control of Bot Operation: A supervisor can take control of the bot's operation and proceed with the customer interaction. This transition can occur without the customer being made aware that a live agent has assumed control, or the supervisor can inform the customer. Once a supervisor decides to take control, the bot is interrupted by the orchestration platform, and control is passed to an exception handler, such as an Interrupt Service Routine (ISR). While in the ISR, a supervisor can perform various tasks, and may later relinquish control back to the bot. If control is returned to the bot, it first assimilates the latest context and then resumes execution within the conversational flow.

Inputs provided via any one or more of the foregoing controls may also be used support training for the bot. If a supervisor alters the bot's behavior during its conversation with a customer, then this can be used as training input for the bot's artificial intelligence/machine learning, such as via training of the bot's a neural network.

In other embodiments, one or more of the following intervention methods are provided for initiating/maintaining human intervention during an active customer-bot conversation:

1) Metrics-Based Trigger Conditions: The bot, and/or underlying conversational AI platform, computes multiple customizable metrics in real-time during a conversation. The bot's metrics and/or associated trigger conditions may be manually and/or automatically defined. When one of the trigger conditions becomes “true” during a conversation, an event will be placed in a supervisor queue of one or more associated supervisor's communication device. Every subscriber to the queue will then receive an alert within their Bot Operations Dashboard of their respective communication device. For example, an alert may be provided to a specific supervisor's communication device (e.g., via round-robin or other selection methodology) or presented to a pool of supervisors' devices and the first responding subscriber to the alert will take ownership for intervening in the bot conversation. Representative metrics include one or more of, but are not limited to:
i) Number of dialog turns in a conversation;
ii) The customer's “think time” during the last dialog turn;
iii) Average customer think time during the conversation;
iv) The number of times a particular flow has executed; and/or
v) Any psycholinguistic attributes included in the last customer turn (e.g., shouting, cursing, frustration, etc.).

2) Human Initiated Intervention: Supervisors may periodically review the latest metrics (see above) for one or more bot conversation within their Bot Operations Dashboard. Metrics values may be color-coded, such as based upon a defined range for each metric (green, orange, red, etc.) for easier human readability. Furthermore, supervisors may drill down into each ongoing conversation for dialog turn-level monitoring of the conversation. A supervisor may decide, based on metrics or the dialog turns, that an intervention is warranted and then take appropriate action.

3) Bot Initiated Intervention: A new bot construct is provided that is analogous to an exception handler within a programming language. Intervention points can be directly incorporated within the bot's conversational flow. The underlying conversational platform issues an alert to the Bot Operations Dashboard when the bot has reached an intervention point in its conversation flow. For example, the platform could initiate a REST API call to the Bot Operations Dashboard that may include a description of the intervention point, a transcript of the ongoing conversation, customer details, and/or any computed real-time metrics. A supervisor may then decide to “take” the intervention request and initiate an intervention in response to the bot's “request for intervention”.

In other embodiments one or more of the following functions are provided:

1) Bot Admin Role: The orchestration engine supports the concept of a bot admin role that provides access to each bot within a tenant. The bot admin role will be securely accessed by the supervisor/agent and then used to supplement or take control over the bot's operation.

2) Bot Operations Dashboard: The Bot Operations Dashboard provides a visualization method for active bots to report status; enable supervisors to “pin” conversations of interest, such as potentially troublesome conversations, for closer monitoring and/or enable bots to signal alerts when they have encountered Intervention Points within their conversation flows. The Bot Operations Dashboard visualizes ongoing conversations with their captured and computed conversation metrics and parameters and supports interactive filtering, sorting, and grouping of conversations by selected metrics/parameters subsets.

3) Query Interfaces: The Bot Operations Dashboard will expose a powerful query interface allowing supervisors to submit queries which can cover all or a subset of conversations, their associated real-time metrics, customer profile properties (such as name, language, location, selected conversation platform, influencer score, etc.), bot-recognized intents and entities in conversations, a filter for any outputs that match conversations, and their set of real-time metrics with transcripts. The query interface may have a “Simple Mode” in which a GUI assists the query assembly and execution and/or an “Expert Mode” in which the supervisor may use a query language via command line interface. Each bot may also expose a query interface that unlocks when a supervisor enters the bot admin role and undergoes authentication. The interface supports queries over its own real-time metrics and transcripts for ongoing conversations.

4) Interruptible Orchestration Logic: In order for the supervisor to take control over a bot, the orchestration engine is interruptible. This will be analogous to providing support for an exception handler, such as nan Interrupt Service Routine (ISR) that is invoked by the orchestration engine when it receives an admin access command from the supervisor. Upon completion of any manual bot operations and once the bot admin role has been exited, the exception handler will then relinquish control back to the original point within the orchestration logic flow.

5) Orchestration Engine: The orchestration engine may dynamically enable augmentations to its programmatic logic flow(s) based upon any customized/personalized bot behavior that is invoked by the admin user (i.e., supervisor). A suite of bot macro commands may be defined for use within the bot admin role. For example, “issue_refund” might be one such macro. If the supervisor entered “issue_refund [$56.89]” while in the bot admin role, then the conversation and events to refund $56.89 to the customer would be executed, such as to present a particular message on a customer device (e.g., “Please accept my apologies. Additionally, we have refunded your account in the amount of $56.89.”) and trigger the back-end systems accordingly, such as to perform the refund. The macro will invoke other operations, such as those within backend systems to perform the customer refund. Prior to leaving the bot admin role, the orchestration engine may also present a prompt to the supervisor to determine whether the bot's existing conversational logic flows should be augmented with any new flows that were just enacted by the supervisor. If the admin user accepts these changes, then the new logic flows will be added into a test mode. Such flows may not advance into actual production until approved by an appropriate authority.

Exemplary aspects are directed to:

A system for training a first artificial intelligence (AI) agent, comprising: a network interface to a communications network; at least one processor having machine-readable instructions maintained in a non-transitory storage that when read by the processor cause the processor to perform: presenting, to a supervisor node, a first indicia of an interaction between the first AI agent and a first customer conducted over the communications network, wherein the interaction comprises a first set of communication elements selected to resolve a work item; receiving a signal from a supervisor node; in response to receiving the signal from the supervisor node, selecting a second set of communication elements selected in accordance with the signal; and replacing the first set of communication elements with a second set of communication elements.

A system for training a first artificial intelligence (AI) agent, comprising: a network interface to a communications network; at least one processor having machine-readable instructions maintained in a non-transitory storage that when read by the processor cause the processor to perform: presenting, to a supervisor node, a first indicia of an interaction between the first AI agent and a first customer conducted over the communications network, wherein the interaction comprises a first set of communication elements selected to resolve a work item; receiving a signal from a supervisor node; in response to receiving the signal from the supervisor node, selecting a second set of communication elements selected in accordance with the signal; replacing the first set of communication elements with a second set of communication elements; and performing a training stage on the AI agent comprising the second set of communication elements.

A method for training a first artificial intelligence (AI) agent, comprising: presenting, to a supervisor node, a first indicia of an interaction between the first AI agent and a first customer conducted over a communications network, wherein the interaction comprises a first set of communication elements selected to resolve a work item; receiving a signal from a supervisor node; in response to receiving the signal from the supervisor node, selecting a second set of communication elements selected in accordance with the signal; replacing the first set of communication elements with a second set of communication elements; and providing the signal as a training input to the AI agent to alter subsequent interactions determined to be similar to the interaction.

Any of the above aspects:

Wherein the first AI agent provides an alert to the supervisor node that, when received by the supervisor node, causes the supervisor node to activate an alternating circuit causing the display to emphasize the first interaction over at least one interaction comprising a different AI agent and a corresponding different customer.

Wherein the AI agent provides the alert in response to determining the interaction comprises an indiciation that the work item is at risk for successful resolution absent receiving the signal.

Wherein the AI agent determines the interaction comprises indiciation that the work item is at risk for successful resolution, further comprises determining the interaction comprises at least one of more iteration turns than a previously determined threshold, a topic irrelevant to the work item or communication content provided by the first customer further determined to comprise an expression of frustration, an amount of time expected for one or more responses from the customer exceeding a threshold amount of time for the one or more responses.

Wherein the AI agent determines the interaction comprises indiciation that the work item is at risk for successful resolution, further comprises determining the interaction matches a pattern associated with at least one prior interaction known to end with at least one of an associated work item of the interaction not being resolved or incorporation of an input from a prior supervisor.

Wherein the AI agent provides the alert in responce to determining the interaction occurs upon reaching a previously determined step in the interaction of a number of steps of the interaction.

Wherein the supervisor node is further presented with a plurality of indicia of ongoing interactions each comprising an additional AI agent and a corresponding additional customer.

Wherein the supervisor mode receives a selection of one of the plurality of indicia and, in response presents the selected one of the plurality of indicia in a designated portion of a display of the supervisor mode allocated for priority interactions.

Wherein the AI agent, in accordance with the signal, alters a portion of the interaction that is provided by the AI agent to be at least one of more or less verbose, more or less friendly, more or less formal, or more or less accommodating

Wherein the signal is provided as a training input to the AI agent to alter subsequent interactions determined to be similar to the interaction.

Wherein the AI agent reverts to a prior training, before the signal was provided to the AI agent, to remove the training input from the AI agent.

Wherein the second set of training inputs is provided by the supervisor node.

Further comprising performing the training stage on the AI agent further comprising the first set of communication elements and the signal.

Wherein performing the training stage further comprises indicia of work item resolution success.

Wherein the second set of training inputs comprises communication content provided by the supervisor node.

Wherein the signal, alters a portion of the interaction that is provided by the AI agent with respect to at least one of verboseness, friendliness, formality, or accommodating.

Wherein the AI agent provides the alert in response to determining the interaction comprises an indiciation that the work item is at risk for successful resolution absent receiving the signal.

Wherein the determining that the interaction comprises an indiciation that the work item is at risk for successful resolution, further comprises the AI agent determining the interaction comprises at least one of more iteration turns than a previously determined threshold, a topic irrelevant to the work item or communication content provided by the first customer further determined to comprise an expression of frustration, an amount of time expected for one or more responses from the customer exceeding a threshold amount of time for the one or more responses.

A system on a chip (SoC) including any one or more of the above aspects.

One or more means for performing any one or more of the above aspects.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a first display presented on a supervisor node in accordance with embodiments of the present disclosure;

FIG. 4 depicts a second display presented on a supervisor node in accordance with embodiments of the present disclosure;

FIG. 5 depicts a third display presented on a supervisor node in accordance with embodiments of the present disclosure;

FIG. 6 depicts a fourth display presented on a supervisor node of in accordance with embodiments of the present disclosure;

FIG. 7 depicts a process in accordance with embodiments of the present disclosure;

FIG. 8 depicts a third system in accordance with embodiments of the present disclosure; and

FIG. 9 depicts a dashboard in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference to one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

An AI agent may be embodied as a neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

A bot utilizes a neural network in order to be trained on how to conduct an interaction with a human over a network, such during a text (e.g., chat, SMS, email), voice, and/or video-based interaction. Conducting the interaction strives to be responsive to individual conversation elements (e.g., what a customer says) and provide responses selected to lead to a successful conclusion of a work item. A work item may be, or be one reason, for the interaction and may include, but is not limited to, providing information (e.g., update an address, provide information related to a loan, etc.), receiving information (e.g., obtain account balance, status inquiry, etc.), performing an action (e.g., purchase an airline ticket, transfer funds, etc.), receiving assistance (e.g., technical support, activate an account, etc.), etc.

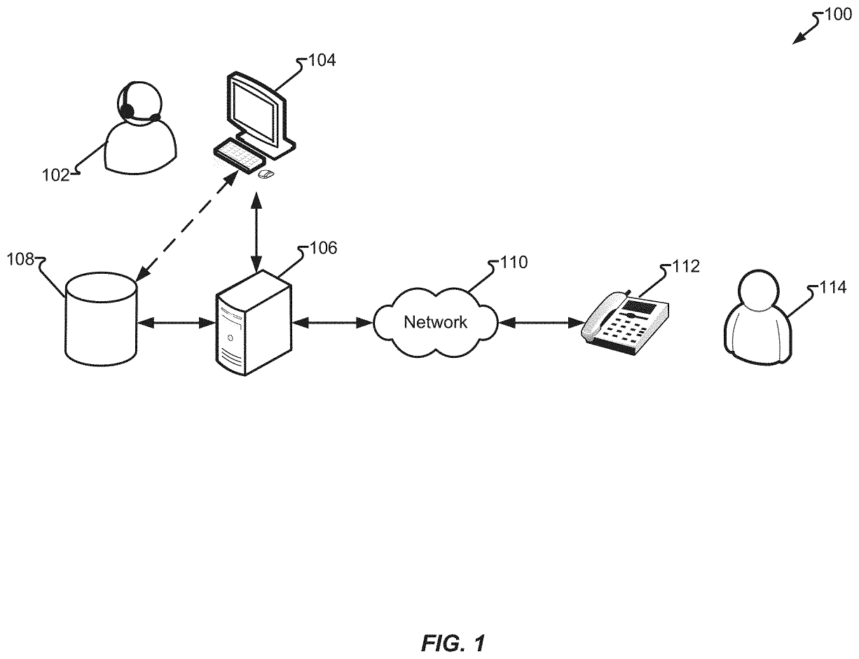

FIG. 1 depicts system 100 in accordance with embodiments of the present disclosure. In one embodiment, customer 114 utilizes customer communication device 112 to conduct an interaction with an artificial intelligence (AI) agent executed by one or more processors of server 106, the interaction may comprise communication portions provided by the AI agent to customer communication device 112 and vice versa, such as to resolve a work item. Customer communication device 112 may be embodied as a device comprising an interface to network 110 to enable communications thereon. The interaction may be conducted in text (e.g., simple messaging service (SMS), chat, email, etc.), audio (i.e., voice), and/or video (e.g., audio-video, video only). Accordingly, customer communication device 112 may comprise or have attached thereto hardware required to enable the particular form of the communication for the interaction. For example, customer communication device 112 may comprise a camera and/or display to accommodate video-only or other communication forms comprising video, microphone and speaker to accommodate voice communications, and/or keyboard to accommodate text-based communications. Accordingly, network 110 may comprise a public packet switched network (e.g., Internet) and/or other networks (e.g., cellular telephone voice, cellular telephone data, ethernet, WiFi, Bluetooth, etc.). Server 106 executing the AI agent may further comprise text-to-speech, speech recognition, video recognition, avatar generation, and/or other operations to receive and provide interaction portions by the AI agent and/or receive and process interaction portions by customer 114.

In algorithmic-based automated agents, the automated agent gathers one or more inputs and, based on the value thereof, programmatically selects a response to be delivered to the customer. However, in AI-based agents, a volume of training inputs (e.g., past customer-AI agent interactions and/or past customer-live agent interactions) is provided and when the AI agent determines a current communication with a current customer 114 is sufficiently similar to what the AI agent “learned” from the training, the AI agent provides a response as “learned” from the training session. It is not always clear what inputs had more or less sway over determining the AI agent's response. Training sets preferably have a large number of inputs (e.g., several hundred at least, preferably many thousands). However, training may be limited to small data sets, such as when a particular topic or work item is uncommon. As a result the AI agent may be trained to respond on a small number of inputs and base a decision on other elements of the communication (e.g., subject matter, customer attribute, time/day attribute, speed of resolution, etc.). For example, a prior customer may be known to be problematic (e.g., excessive returns, using and returning merchandise, etc.) and denied a refund based on the identity of the customer. If another such an interaction is used to train the AI, a subsequent customer, such as one having common demographic attributes or having purchased the same or similar item, may be determined by the AI agent to be equivalent to the prior customer. As a result, if the current customer attempts a legitimate return of a defective item, the AI agent may erroneously deny a refund and/or seek another less accommodating resolution (e.g., 10% off a next purchase, etc.). Accordingly, escalation to include supervisor node 104 operated by supervisor 102 may be initiated by customer 114, the AI Agent, or when supervisor 102 is monitoring the interaction, by supervisor 102 themselves.

Training of the AI agent is unlikely to cover every conceivable issue and, as a result, the interaction may take a course of action that requires intervention by supervisor node 104. For example, customer 114 may be particularly upset or the communication describes a first-encounter of a particular work item. Supervisor 102 may be required just to overcome communication issues (e.g., the AI agent is not trained on a particular language or the AI agent is unable to understand what customer 114 is saying, such as due to a speech impediment).

If an interaction is starting to show indiciations that a successful resolution of the work item is now in question, supervisor 102 may be required to intervene. Often, only minimal involvement by supervisor 102 is required, such as to nudge the conversation in a slightly different direction (e.g., make the AI agent 5% more verbose, etc.). The communication portion provided by the AI agent is then modified according to previously determined modifications. After the implementation of such changes, supervisor 102 may discontinue further involvement. At other times, more explicit involvement may be required, such as to receive inputs on supervisor node 104 that translate directly to content delivered to customer communication device 112. One involvement may be in the form of communications that may be triggered via a command line input or input to a graphical interface presented on supervisor node 104. For example, a macro may be defined to comprise explicit statements for providing to customer communication device 112 via the AI agent and/or alterations to the behavior of the AI. Macros may take one or more parameters (see “issue_refund” above).

Data storage 108 may maintain the hyperplanes utilized by the AI agent executing on server 106 and/or other data or instructions. Additionally or alternatively, data storage 108 may be utilized to maintain options, statuses, macros, etc. for use by the AI agent and/or supervisor node 104. Data storage 108 may be embodied as a memory or local storage, or as a more complex and voluminous storage (e.g., storage array, cloud storage, server farm, etc.).

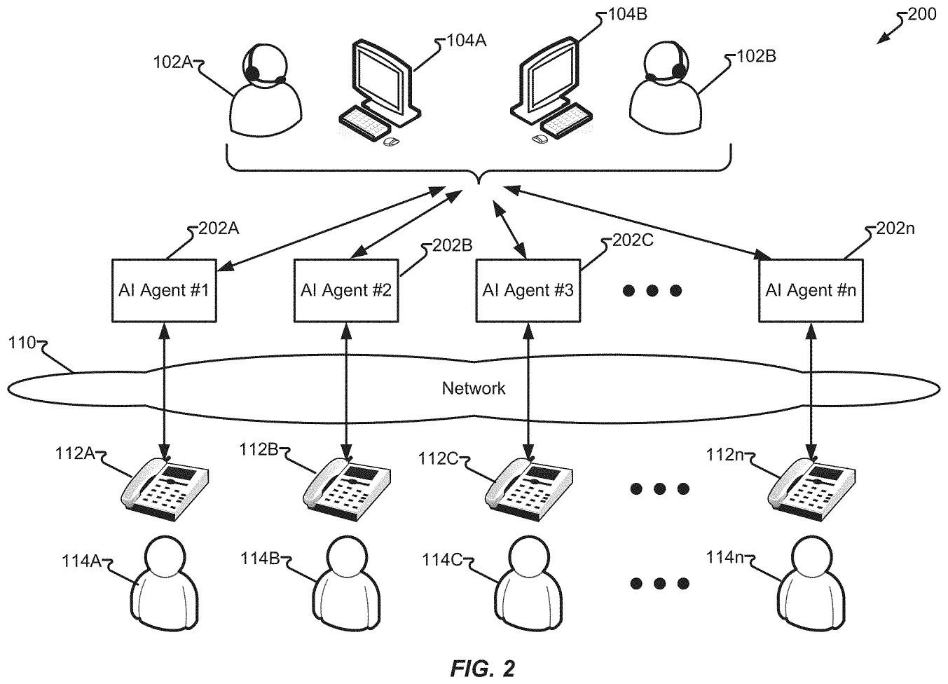

FIG. 2 depicts system 200 in accordance with embodiments of the present disclosure. In one embodiment, system 200 illustrates multiple tenant AI agents, namely AI agents 202A-202n, which may be executed by a single server, such as when server 106 is embodied as a single server, or a plurality of servers, such as when sever 106 is embodied as a plurality of servers. Each of AI agents 202A-202n are currently engaged in an interaction with a corresponding one of customer 114A-114n, the interaction further comprising communications utilizing customer communication devices 112A-112n, respectively, over network 110. Each of communication devices 112A-112n may be homogenous, as illustrated, or heterogeneous and/or accommodate similar or dissimilar types of communication (e.g., text, voice, etc.) are currently underway.

Supervisor 102 and supervisor node 104 may be embodied as a plurality of supervisors 102A-102B, and a corresponding plurality of supervisor nodes 104A-104B. It should be appreciated that the number of supervisors 102 and supervisor nodes 104 may be more than two.

One or more of the current interactions may show indiciations that the interaction is not proceeding as expected and an intervention may be required. Additionally or alternatively, an automatic connection may be made to one or more supervisor node(s) 104 to include the one or more supervisor node(s) 104 in the communication. An indiciation that an interaction is not progressing as expected may be explicit, such as a particular customer 114 requesting a supervisor, or implicit, such as an AI agent determining that the content provided by customer 114 is showing signs of frustration, stress, dissatisfaction, etc., which may be explicitly stated (e.g., “I'm getting frustrated.”) or implied (e.g., speech provided by “talking through one's teeth”), repeating the same steps, an interaction taking an excessive number of “turns,” (i.e., one of the AI agent or the customer provides a communication element to the communication and then the other of the AI agent or the customer provide a communication element to the communication), content indiciating dissatisfaction (e.g., “No. That's not good enough,” “You don't seem to care,” etc.), wherein a communication element is one, usually of a set of communication elements of an interaction, such as a sentence or series of related sentences provide as a “turn” which ends when the party ends speaking, such as to wait for a reply. The communication elements are selected to accomplish a particular task, such as resolve the work item, or a portion of the work item, or accomplish an ancillary task, such as to express concern, build trust, etc. Communication elements may be embodied as a single utterance (e.g., “yeah,” “huh?, etc.), a word (e.g., “yes,” “no,” “maybe,” “interesting,” etc.) or series of words, sentences, sentence portions, series of sentences, etc. A communication element, barring interruption, is delivered from start to finish and then, absent conclusion of the interaction, waits for the receiving party to reply with one or more communications elements of their own. The communication elements may be delivered by the AI agent as voice, text, sign language, or other communication portion for the communication type currently utilized.

When a conversation is not progressing normally, the respective one of AI agents 202A-202n, may query a data repository, such as data storage 108, to see if a similar conversation has occurred in the past and, if so, how it was resolved. If the AI agent is able to provide the resolution, the AI agent may do so. However, if the prior interaction did not have a successful resolution or a resolution was achieved by incorporating a supervisor, then the AI agent may alert a supervisor.

In one embodiment, one of a number of supervisors 102 may receive notifications via a selection algorithm (e.g., round robin, random, availability, etc.). In another embodiment, one supervisor 102 may indiciate an interest and, if granted, such as by server 106, the interested supervisor 102 takes ownership of the interaction to the exclusion of other supervisors 102. Additionally or alternatively, supervisors may manually select a particular interaction, such as in response to a search query issued to server 106 and/or data storage 108 (e.g., “show current interactions rescheduling flights to Paris,” “Show current interactions with customers located in [an area recently hit by a storm],” “show current interactions that are 15% over the expected resolution time.” etc.).

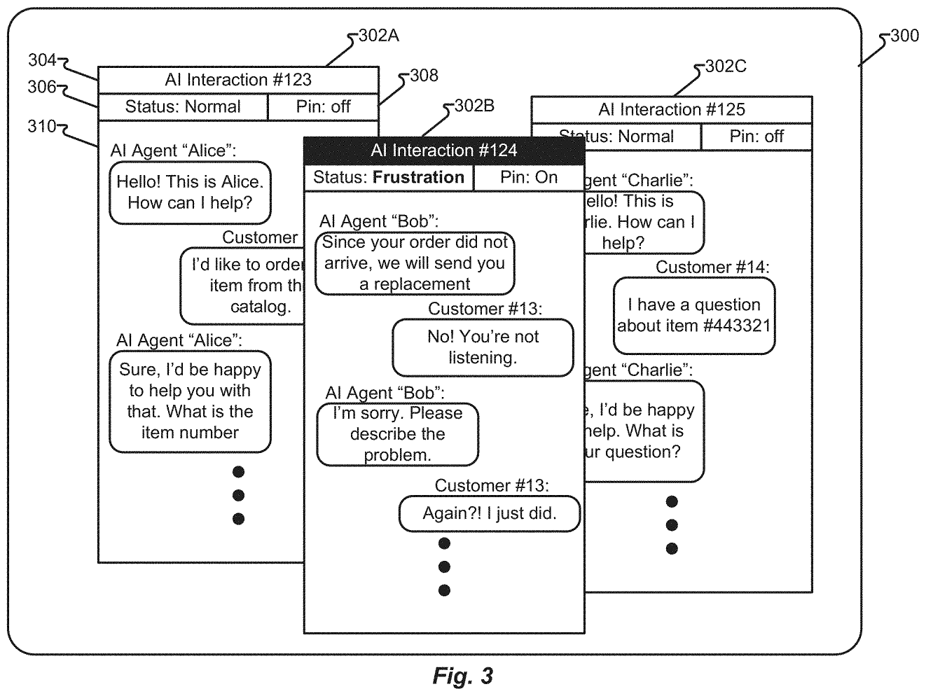

FIGS. 3-6 illustrate display 300. In one embodiment, display 300 further presents content as the output of a “dashboard” operation monitoring AI agents, interactions comprising the AI agents, and receiving inputs to further query or alter the behavior of any one or more AI agents.

FIG. 3 depicts display 300 as presented on supervisor node 104 in accordance with embodiments of the present disclosure. Display 300 visually represents graphical elements, such as a display of supervisor node 104. A number of interactions are currently underway. A copy (if the interaction utilizes text) or transcription (if the interaction utilizes voice or visual representations) is provided for each interaction, such as in window 302A, 302B, and 302C.

In one embodiment, each of window 302, and specifically illustrated with respect to window 302A, comprises identifier 304, status 306, pin state/toggle 308, and content 310, each of windows 302A-C may be similarly presented. It should be appreciated that in other embodiments, more or fewer elements may be presented in any one or more windows 302A-302C. The interaction associated with window 302A and 302C may be progressing normally, as represented by an absence of highlighting or other emphasis. The interaction associated with window 302B is not progressing normally, as illustrated by one or more of identifier 304 being presented in an alternate color, font, etc. so as to be readily differentiated from windows 302A and 302C. Additionally or alternatively, pin field 308 of window 302B is indiciated as “On” indiciating that the window is “pinned,” such as to automatically move window 302 to a particular portion of display 300 selected to draw attention (e.g., the center) by the user. If more than one window 302 is pinned, the windows may be automatically tiled (e.g., presented side-by-side) or other pattern, such as to make a window of an interaction determined to most require attention to be closest to the particular portion of display 300 wherein windows of interactions of all the interactions determined to require less attention are placed as close as possible to the particular portion of display 300 but without obscuring a window of a higher priority interaction.

It should be appreciated that color, bolding, flashing text/graphics, font sizes, etc., may be utilized to convey meaning of a particular displayed information. For example, an interaction that is beginning to deviate from an expected course, may be represented as text in a yellow bubble, an interaction that is problematic, may be represented in an orange bubble, and an interaction that requires immediate action represented in a red bubble.

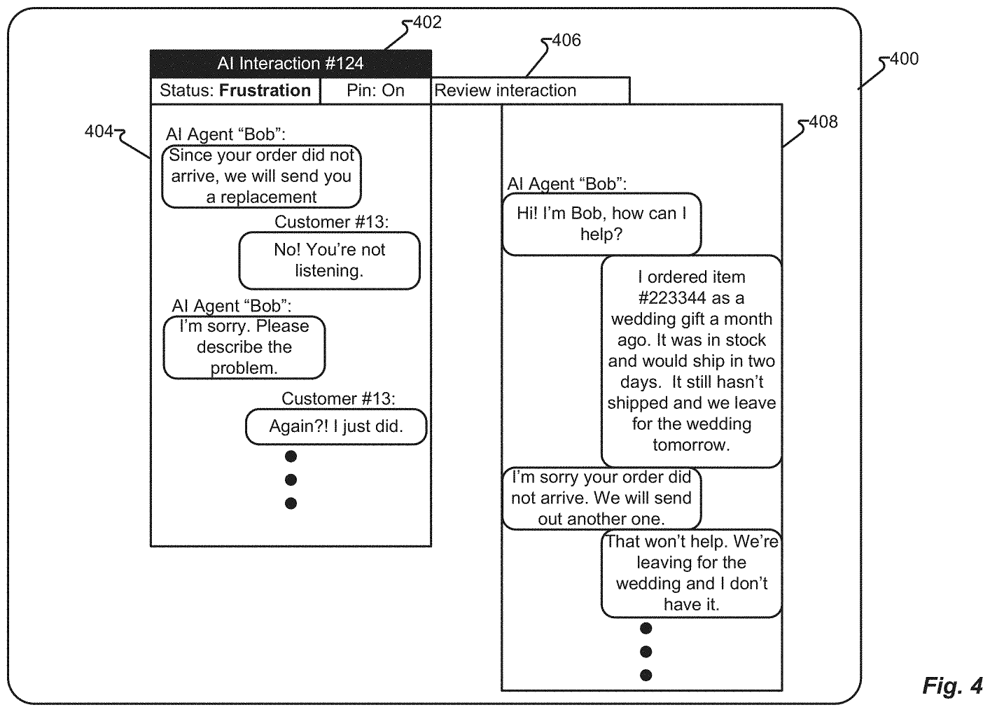

FIG. 4 depicts display 400 as presented on supervisor node 104 in accordance with embodiments of the present disclosure. In one embodiment, supervisor node 104 may present window 402 comprising a current portion of interaction 404. Review interaction option 406 may be provided, such as scrolling window 404 or, as illustrated, separate window 408. Separate window 408 may comprise earlier communication elements of the current interaction and/or communication elements of a prior communication with the same customer 114.

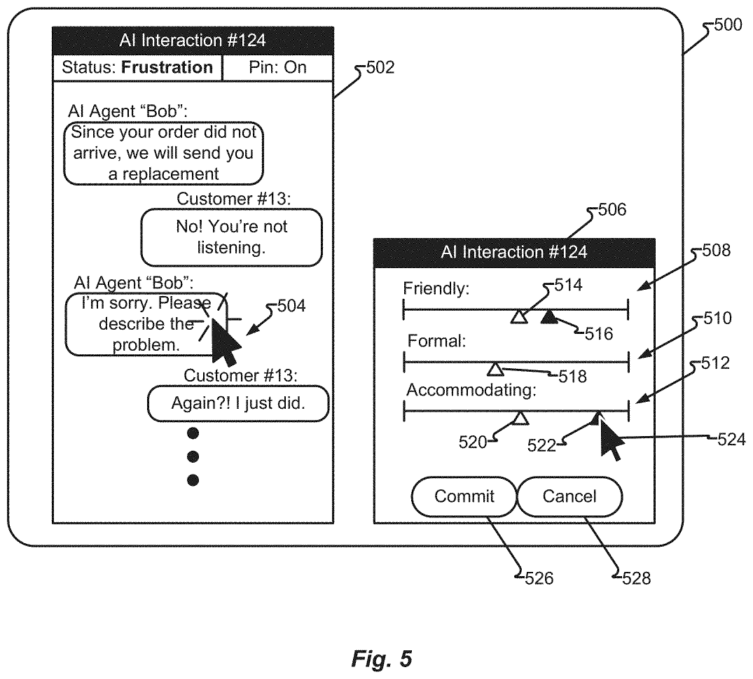

FIG. 5 depicts display 500 as presented on supervisor node 104 in accordance with embodiments of the present disclosure. In one embodiment, supervisor node 104 may present window 502. An input may be received thereon, illustrated as pointer 504 operated by an input device (e.g., mouse, touchpad, touchscreen, etc.). It should be appreciated that alternative selection means may be provided without departing from the scope of the embodiments provided herein.

In one embodiment, clicking on window 402 brings up dialog window 506 to provide current settings and/or input interface(s) to change the current settings, for the AI agent current engaged in the interaction associated with window 502. For example, the AI agent may have settings for friendly 508, formality 510, and accommodating 512 Additional, fewer, or different settings may also be utilized. If supervisor 102, upon reviewing window 502 and noting the customer is frustrated, determines that the AI agent should be more friendly and accommodating, as a result, an input is provided to supervisor node 104 to cause current friendliness setting 514 to be moved to new friendliness setting 516, as illustrated, currently formality setting 518 is presently unchanged; and pointer 524 is currently altering current accommodating setting 520 to new accommodating setting 522. As a further option, the changes input may take effect immediately or upon entry of commit option 526. Alternatively, changes are discarded if cancel option 528 is selected. In response, the associated AI agent will now seek communication elements that are similar in content to those currently selected, but which are more friendly and accommodating.

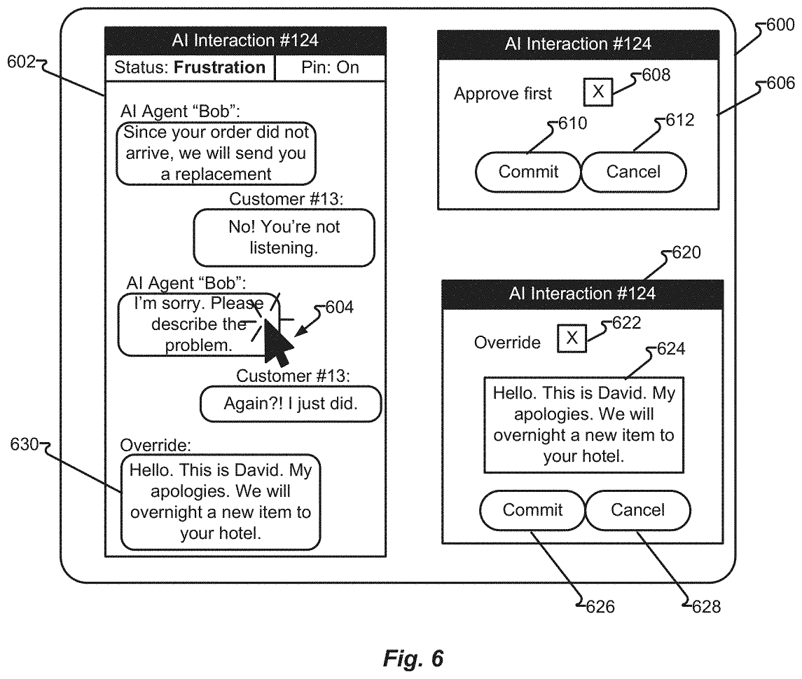

FIG. 6 depicts display 600 as presented on supervisor node 104 of in accordance with embodiments of the present disclosure. In one embodiment, window 602 is presented on display 600, such as a display of supervisor node 104. The customer (one of customer 114) involved in the interaction has become frustrated and, in order to remedy the customer's frustration, supervisor 102 may which to take a more active role in the operations of the AI agent.

In one embodiment, an input may be received thereon, illustrated as pointer 604 operated by an input device (e.g., mouse, touchpad, touchscreen, etc.), such as a mouse-click to cause window 606 to be presented on display 600. Window 606 provides option 608 that, when selected, cause the AI agent to present communication elements to be presented to the corresponding customer 114, but not yet presented to customer communication device 112, for an approval input. If an approval input is received (not shown) the communication element is delivered to customer communication device 112. If the approval is not received, or explicitly not approved, the AI agent may select an alternative communication element or automatically launch window 620 to receive an explicit input to become a communication element presented to customer communication device 112.

As a result of inputs to window 606 or, alternatively, an input to window 602 or other input component of display 600, window 620 is presented. Selection of override option 622 causes the AI agent to suspend interactions with customer 114. Inputs may be provided directly via an input to supervisor node 104, via dialog box 624 or other input component. The message may be sent in real time (e.g., as typed) to customer communication device 112 or optionally, upon receiving an input to commit option 626. An input to cancel option 628 omits sending the content of dialog 624 to customer communication device 112.

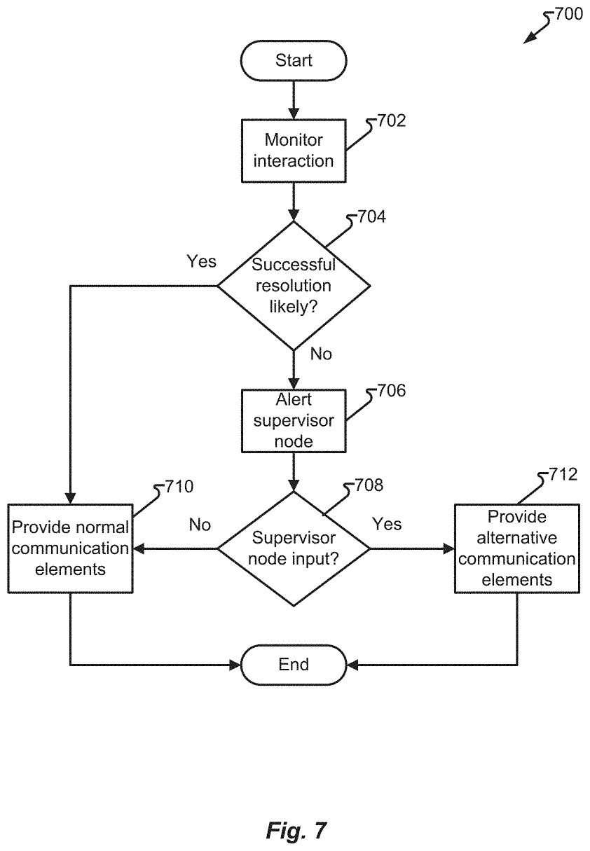

FIG. 7 depicts a process 700 in accordance with embodiments of the present disclosure. In one embodiment, process 700 is embodied as machine-readable instructions that are maintained in a non-transitory data storage, such as a data storage of supervisor node 104 and/or server 106, that when read by a processor cause the processor to perform the steps of process 700.

In one embodiment, process 700 begins and, at step 702, monitors an interaction between an AI agent and a customer. Test 704 determines if successful resolution of the interaction, such as to successfully resolve a work item, is likely. Successful resolution, or the absence thereof, may be determined from communication elements provided by the customer, such as the use of profanity, repeating statements, interactions taking longer than a threshold amount, explicit statements, etc. If test 704 determines that successful resolution is likely, process 700 continues to step 710 wherein the AI agent proceeds normally and provides a first set of communication elements, such as communication elements selected solely by the AI agent. The AI agent may omit providing communication elements but continues to receive the communication elements provided by the customer and the supervisor to further train the AI agent, such as to be able to automatically, and without human intervention, successfully complete a subsequent interaction with similar attributes (e.g., customer attributes, work item attributes, etc.).

If test 704 is determined in the negative, processing continues to step 706 wherein a supervisor node is provided is alerted and, in response thereto, an alerting circuit activated, such as to cause indicia of an interaction (e.g., a window comprising text of an interaction) to become emphasized (e.g., relocated on a display, emphasized with color, flashing, pop-up message, sound/tone, etc.). Test 708 determines if a supervisor node has provided an input and, if determined in the negative, processing continues to step 710. If test 708 is determined in the affirmative, processing continues to step 712. Step 712 provides an alternative communication element(s) in place of one or more communication elements that were, or would be, selected by the AI agent. Step 712 may incorporate a nudge, such as to be more friendly (see FIG. 5) and/or explicitly provided communication elements received from the supervisor node. Process 700 may end or, optionally, continue back to step 702 in a continual loop to continue monitoring the interaction between the customer and AI agent until the interaction is terminated. Success and/or failure of the interaction to achieve a desired result (e.g., customer satisfaction, resolve a work item, etc.) and the attributes of the interactions may be provided to the AI agent (or other AI agents) as a training set to further train the AI agent to be more likely to resolve with no input, or fewer/less invasive, inputs from a human for any subsequent interactions having similar attributes.

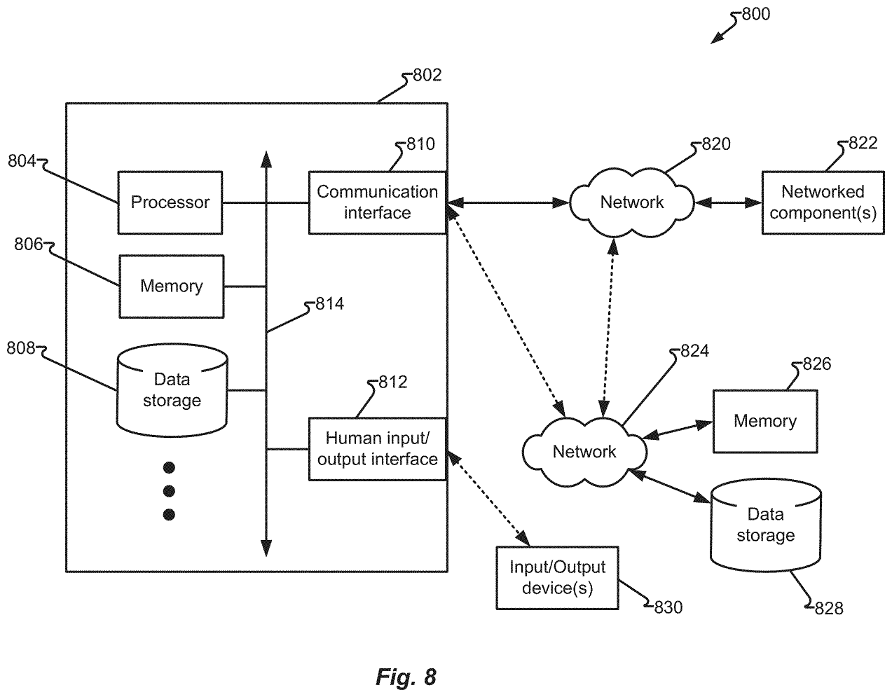

FIG. 8 depicts device 802 in system 800 in accordance with embodiments of the present disclosure. In one embodiment, supervisor node 104 and/or server 106 may be embodied, in whole or in part, as device 802 comprising various components and connections to other components and/or systems. The components are variously embodied and may comprise processor 804. The term “processor,” as used herein, refers exclusively to electronic hardware components comprising electrical circuitry with connections (e.g., pin-outs) to convey encoded electrical signals to and from the electrical circuitry. Processor 804 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 814, executes instructions, and outputs data, again such as via bus 814. In other embodiments, processor 804 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 804 is a non-transitory computing device (e.g., electronic machine comprising circuitry and connections to communicate with other components and devices). Processor 804 may operate a virtual processor, such as to process machine instructions not native to the processor (e.g., translate the VAX operating system and VAX machine instruction code set into Intel® 9xx chipset code to enable VAX-specific applications to execute on a virtual VAX processor), however, as those of ordinary skill understand, such virtual processors are applications executed by hardware, more specifically, the underlying electrical circuitry and other hardware of the processor (e.g., processor 804). Processor 804 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 804, device 802 may utilize memory 806 and/or data storage 808 for the storage of accessible data, such as instructions, values, etc. Communication interface 810 facilitates communication with components, such as processor 804 via bus 814 with components not accessible via bus 814. Communication interface 810 may be embodied as a network port, card, cable, or other configured hardware device. Additionally or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, speaker, microphone, still and/or video camera, etc. In another embodiment, communication interface 810 may comprise, or be comprised by, human input/output interface 812. Communication interface 810 may be configured to communicate directly with a networked component or utilize one or more networks, such as network 820 and/or network 824.

Network 110 may be embodied, in whole or in part, as network 820. Network 820 may be a wired network (e.g., Ethernet), wireless (e.g., WiFi, Bluetooth, cellular, etc.) network, or combination thereof and enable device 802 to communicate with networked component(s) 822. In other embodiments, network 820 may be embodied, in whole or in part, as a telephony network (e.g., public switched telephone network (PSTN), private branch exchange (PBX), cellular telephony network, etc.)

Additionally or alternatively, one or more other networks may be utilized. For example, network 824 may represent a second network, which may facilitate communication with components utilized by device 802. For example, network 824 may be an internal network to a business entity or other organization, such as a contact center, whereby components are trusted (or at least more so) that networked components 822, which may be connected to network 820 comprising a public network (e.g., Internet) that may not be as trusted.

Components attached to network 824 may include memory 826, data storage 828, input/output device(s) 830, and/or other components that may be accessible to processor 804. For example, memory 826 and/or data storage 828 may supplement or supplant memory 806 and/or data storage 808 entirely or for a particular task or purpose. For example, memory 826 and/or data storage 828 may be an external data repository (e.g., server farm, array, “cloud,” etc.) and enable device 802, and/or other devices, to access data thereon. Similarly, input/output device(s) 830 may be accessed by processor 804 via human input/output interface 812 and/or via communication interface 810 either directly, via network 824, via network 820 alone (not shown), or via networks 824 and 820. Each of memory 806, data storage 808, memory 826, data storage 828 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 830 may be a router, switch, port, or other communication component such that a particular output of processor 804 enables (or disables) input/output device 830, which may be associated with network 820 and/or network 824, to allow (or disallow) communications between two or more nodes on network 820 and/or network 824. One of ordinary skill in the art will appreciate that other communication equipment may be utilized, in addition or as an alternative, to those described herein without departing from the scope of the embodiments.

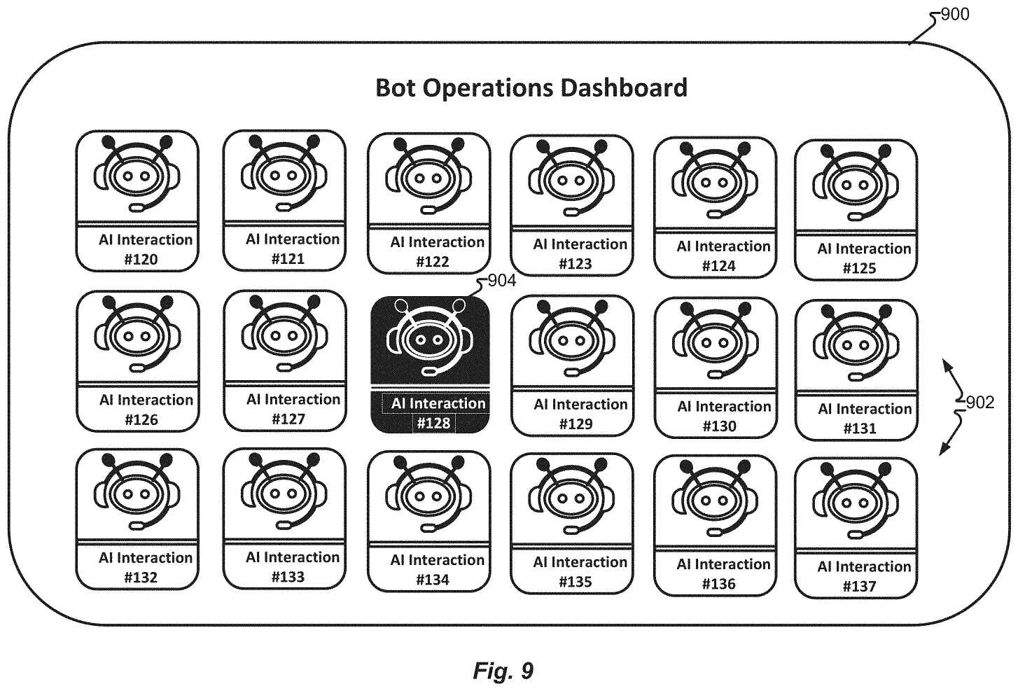

FIG. 9 depicts dashboard 900 in accordance with embodiments of the present disclosure. In one embodiment, dashboard 900 may be provided on a display of device, such as supervisor node 104. In one embodiment, iconic representations 902 are provided for each of executing AI agents 202 and wherein the icon is presented in accordance with a status. For example, iconic representation 904 is provided in inverse colors so as to stand out from the pool of iconic representations 902 in order to provide indicia of the state of the corresponding AI agent 202 (“AI Interaction #128), such as one requiring attention.

As can be appreciated by those of skill in the art, other means of presenting iconic representations 902, including iconic representation 904 indicating a need for attention or a specific action, may be provided. For example, variations in position with dashboard 900 may be provided (e.g., those in the top, top-left, etc. require action). In other embodiments, color is provided (e.g., green=normal/good, yellow=issues may be present/non-optimal, red=failure/action required, etc.). Changes in relative size of iconic representations 902, placement, overlay (e.g., pinning), etc., or combinations thereof are also contemplated by the embodiments herein.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22nm Haswell, Intel® Core® i5-3570K 22 nm Ivy Bridge, the AMD® FXTM family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARIV1926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for training a first artificial intelligence (AI) agent, comprising:
a network interface to a communications network;
at least one processor having machine-readable instructions maintained in a non-transitory storage that when read by the processor cause the processor to perform:
presenting, to a supervisor node, a first indicia of an interaction between the first AI agent and a first customer conducted over the communications network, wherein the interaction comprises a first set of communication elements selected to resolve a work item;
receiving a signal from a supervisor node;
in response to receiving the signal from the supervisor node, selecting a second set of communication elements selected in accordance with the signal; and
replacing the first set of communication elements with a second set of communication elements.

2. The system of claim 1, wherein the first AI agent provides an alert to the supervisor node that, when received by the supervisor node, causes the supervisor node to activate an alternating circuit causing the display to emphasize the first interaction over at least one interaction comprising a different AI agent and a corresponding different customer.

3. The system of claim 1, wherein the AI agent provides the alert in response to determining the interaction comprises an indiciation that the work item is at risk for successful resolution absent receiving the signal.

4. The system of claim 3, wherein the AI agent determines the interaction comprises indiciation that the work item is at risk for successful resolution, further comprises determining the interaction comprises at least one of more iteration turns than a previously determined threshold, a topic irrelevant to the work item or communication content provided by the first customer further determined to comprise an expression of frustration, an amount of time expected for one or more responses from the customer exceeding a threshold amount of time for the one or more responses.

5. The system of claim 3, wherein the AI agent determines the interaction comprises indiciation that the work item is at risk for successful resolution, further comprises determining the interaction matches a pattern associated with at least one prior interaction known to end with at least one of an associated work item of the interaction not being resolved or incorporation of an input from a prior supervisor.

6. The system of claim 1, wherein the AI agent provides the alert in response to determining the interaction occurs upon reaching a previously determined step in the interaction of a number of steps of the interaction.

7. The system of claim 1, wherein the supervisor node is further presented with a plurality of indicia of ongoing interactions each comprising an additional AI agent and a corresponding additional customer.

8. The system of claim 7, wherein the supervisor mode receives a selection of one of the plurality of indicia and, in response presents the selected one of the plurality of indicia in a designated portion of a display of the supervisor mode allocated for priority interactions.

9. The system of claim 1, wherein the AI agent, in accordance with the signal, alters a portion of the interaction that is provided by the AI agent to be at least one of more or less verbose, more or less friendly, more or less formal, or more or less accommodating

10. The system of claim 1, wherein the signal is provided as a training input to the AI agent to alter subsequent interactions determined to be similar to the interaction.

11. The system of claim 10, wherein the AI agent reverts to a prior training, before the signal was provided to the AI agent, to remove the training input from the AI agent.

12. The system of claim 1, wherein the second set of training inputs is provided by the supervisor node.

13. A system for training a first artificial intelligence (AI) agent, comprising:
a network interface to a communications network;
at least one processor having machine-readable instructions maintained in a non-transitory storage that when read by the processor cause the processor to perform:
presenting, to a supervisor node, a first indicia of an interaction between the first AI agent and a first customer conducted over the communications network, wherein the interaction comprises a first set of communication elements selected to resolve a work item;
receiving a signal from a supervisor node;
in response to receiving the signal from the supervisor node, selecting a second set of communication elements selected in accordance with the signal;
replacing the first set of communication elements with a second set of communication elements; and
performing a training stage on the AI agent comprising the second set of communication elements.

14. The system of claim 13, further comprising performing the training stage on the AI agent further comprising the first set of communication elements and the signal.

15. The system of claim 13, wherein performing the training stage further comprises indicia of work item resolution success.

16. A method for training a first artificial intelligence (AI) agent, comprising:
presenting, to a supervisor node, a first indicia of an interaction between the first AI agent and a first customer conducted over a communications network, wherein the interaction comprises a first set of communication elements selected to resolve a work item;
receiving a signal from a supervisor node;
in response to receiving the signal from the supervisor node, selecting a second set of communication elements selected in accordance with the signal;
replacing the first set of communication elements with a second set of communication elements; and
providing the signal as a training input to the AI agent to alter subsequent interactions determined to be similar to the interaction.

17. The method of claim 16, wherein the second set of training inputs comprises communication content provided by the supervisor node.

17. The method of claim 16, wherein the signal, alters a portion of the interaction that is provided by the AI agent with respect to at least one of verboseness, friendliness, formality, or accommodating.

18. The method of claim 16, wherein the AI agent provides the alert in response to determining the interaction comprises an indiciation that the work item is at risk for successful resolution absent receiving the signal.

19. The method of claim 17, wherein the determining that the interaction comprises an indiciation that the work item is at risk for successful resolution, further comprises the AI agent determining the interaction comprises at least one of more iteration turns than a previously determined threshold, a topic irrelevant to the work item or communication content provided by the first customer further determined to comprise an expression of frustration, an amount of time expected ffor one or more responses from the customer exceeding a threshold amount of time for the one or more responses.
